(19) United States
(12) Patent Application Publication
(10) Pub. No.: US 2005/0227556 A1
(43) Pub. Date: Oct. 13, 2005

(54) Woven wire cloth screen

(76) Inventor: Graham Alexander Robertson, Edinburgh (GB)

Correspondence Address: BARNES & THORNBURG, P.O. BOX 2786, CHICAGO, IL, 60690-2786, US

(21) Appl. No.: 10/500,751

(22) PCT Filed: Oct. 20, 2003
(86) PCT No.: PCT/GB03/04531

§ 371 Date: May 27, 2005

(30) Foreign Application Priority Data
Nov. 2, 2002 (GB) 0225619.6

(51) Int. Cl. B32B 5/26; D03D 19/00; D03D 15/00; D03D 9/00; D04H 1/00

(52) U.S. Cl. 442/5; 442/2; 442/32

(57) ABSTRACT

A woven wire cloth screen is described in which at least one fine mesh cloth overlies a coarser mesh backing cloth and an additional coarser mesh cloth is secured over the fine mesh cloth, whose mesh and wire size at least are selected so as in general to prevent relatively large abrasive particles from making contact with the fine mesh cloth. Two fine mesh cloths may be sandwiched between the coarser cloths. In one screen the backing cloth is 30#×01.280 mm diameter S/S wire, the upper fine mesh is 180#×0.030 mm diameter S/S wire, the lower fine mesh is 160#×0.036 mm diameter S/S wire, and the additional top cloth is 30#×60#×0.160 mm diameter S/S wire. A method of making such a screen is described in which the cloths are in turn laid over a rigid frame to which they are to be bonded and the tension in the wire mesh cloths is achieved using pneumatically powered rams acting on clamps which grip the edges of the cloths. All the rams are of the same size and different tensions are imparted to the cloths by supplying air at differing pressures to the rams acting on the different cloths. In particular a method is described for making a woven wire cloth screen which will withstand highly abrasive large particles such as obtained when drilling through Utsira sand, in which a support frame is located in a jig, a coarse backing cloth is stretched over the frame -and secured between clamping jaws along all four edges and then tensioned by moving all the clamps relatively outwardly by pneumatic rams. A fine mesh wirecloth is then stretched over the first cloth and similarly tensioned by means of a second set of clamps and rams. An additional coarse mesh cloth is then similarly stretched over the fine mesh cloth and tensioned by means of a third set of clamps and rams. Thereafter the cloths are secured to the support frame under pressure. After releasing the pressure, opening the clamping jaws, and trimming surplus wirecloth back to the frame, the finished screen can be removed from the jig. A second fine mesh cloth can be laid over the first fine mesh cloth before the top coarse cloth is applied, and the two fine mesh cloths can be clamped using the same set of jaws and rams.

### FIELD OF THE INVENTION

This invention concerns woven wire cloth screens for filtering liquids from a mixture of solids and liquids, particularly but not exclusively drilling muds. Typically such screens are located in a vibratory shaker to assist in separating the constituents of the mud and to cause the solids left on the wire cloth of the screen to migrate to one end thereof for discharge and collection.

### BACKGROUND

Certain strata produce relatively large highly abrasive particles when drilled, and screens have been found to fail prematurely in use, when drilling through such material. Thus instead of a screen lasting for up to several days before abrasion ruptures the wire cloth, failure has occurred within a few hours.

It is an object of the present invention to provide an improved design of woven wire cloth screen, which overcomes this problem.

### SUMMARY OF THE INVENTION

According to the present invention, in a woven wire cloth screen in which at least one fine mesh cloth overlies a coarser mesh backing cloth, an additional coarser mesh cloth is secured over the fine mesh cloth, whose mesh and wire size at least are selected so as in general to prevent relatively large abrasive particles from making contact with the fine mesh cloth.

In general the tension in wires making up one cloth is arranged to be different from the tension in the wires making up the other cloth and where there are three or more cloths, different tensions may exist in each of the cloths. However it is to be understood that the invention is not limited to arrangements in which each cloth has a different tension from the other(s) and the cloths (or some of them) may have the same tension if appropriate.

The tension of the said additional cloth can affect its performance, and the tension in the mesh of this additional cloth is selected so that it will perform its protective function and not adversely affect the vibration of the fine mesh cloth (or cloths) therebelow.

In general the tension in the additional coarse mesh cloth is greater than that in the fine mesh cloth(s), typically approximately twice the tension in the latter.

Preferably two fine mesh cloths overlie the backing cloth so that one fine mesh cloth is sandwiched between the upper fine mesh cloth and the backing cloth, and the mesh size of the cloth which is so sandwiched is very close to the mesh size of the said upper cloth, and in use assists in de-blinding the upper cloth due to relative vibrational movement between it and the lower fine mesh cloth, and the additional coarser mesh cloth overlies the upper fine mesh cloth.

The mesh size of the additional cloth must be selected with care since if the mesh openings are too large, correspondingly large sharp particles can reach and damage the upper cloth therebelow. Likewise if the openings in the additional cloth are too large the additional cloth may not allow steady migration of separated solids over the screen in use, resulting inter alia in local overloading and failure.

The additional cloth may to advantage have rectangular mesh openings such that for example the openings in the weave are twice as long in one direction as in the other. In general the larger dimensions of the openings in the weave should run parallel to the direction in which separated solids migrate over the surface of the screen in use.

Typically the cloths are stretched over and bonded to a rigid frame and in general such frames are rectangular (although other shaped frames can be used). A screen having a rectangular frame will be referred to as a rectangular screen and in general rectangular screens are normally operated so that the longer dimension of the screen is parallel to the direction in which separated solids migrate over the screen. Therefore as a general rule, where the screen includes a generally rectangular frame to which the cloths are secured, the said additional cloth is fitted to the screen frame so that the larger dimensions of the openings in the weave are parallel to the longer edges of the frame.

Where a screen frame is for example square, and the cloths have rectangular openings, the cloths are preferably fitted to the frame so that the larger dimensions of the mesh openings are parallel to one edge of the frame and the latter is mounted in a shaker so that the direction of solids migration over the screen in use is parallel to the said one edge of the frame.

Examples of Improved Screens

In a preferred screen having a single fine mesh cloth the three cloths may be as follows:—

| | |
|---|---|
| Backing cloth: | 30# × 0.280 mm diameter S/S wire |
| Fine mesh cloth: | 180# × 0.030 mm diameter S/S wire |
| Additional top cloth: | 30# × 60# × 0.160 mm diameter S/S wire. |

In another preferred screen having two fine mesh cloths, the four cloths may be as follows:—

| | |
|---|---|
| Backing cloth: | 30# × 01.280 mm diameter S/S wire |
| Upper fine mesh: | 180# × 0.030 mm diameter S/S wire |
| Lower fine mesh: | 160# × 0.036 mm diameter S/S wire |
| Additional top cloth: | 30# × 60# × 0.160 mm diameter S/S wire |

Tensions in the wire mesh cloths is normally achieved using pneumatically powered rams acting on clamps which grip the edges of the cloths. If (as is usual) all the rams are of the same size, the tensions imparted to the cloths will be proportional to the air pressure applied to the rams acting on the different cloths.

In the case of a three-cloth screen the pressures applied to the three sets of rams may be in the following ratios:—

| Backing mesh | Fine mesh | Additional top mesh |
|---|---|---|
| 2.0 | 1.0 | 1.9 |

In the case of a four cloth screen the pressures applied to the different sets of rams may be in the following ratios:

| Backing | | | |
|---|---|---|---|
| mesh | Lower fine mesh | Upper fine mesh | Additional top mesh |
| 2.0 | 1.0 | 1.0 | 1.9 |

Where the two fine mesh cloths are to have the same tension (as in this last example) they can be tensioned together using the same set of clamps and rams.

If however the tension in one fine mesh cloth is to be different from that in the other fine mesh cloth, then a further set of rams and clamps will be needed to allow each cloth to be tensioned independently of the other.

A screen constructed in accordance with the invention has proved more durable than screens not having the additional cloth when sifting drilling mud recovered from a sea-bed drilling operation as the drill is progressing through sub-sea strata composed of Utsira sand.

The invention also lies in a method of making a woven wire cloth screen which will withstand highly abrasive large particles such as obtained when drilling through Utsira sand, in which a support frame is located in a jig, a coarse backing cloth is stretched over the frame and secured between clamping jaws along all four edges and then tensioned by moving all the clamps relatively outwardly by pneumatic rams, similarly stretching a fine mesh wirecloth over the first cloth and similarly tensioning it by means of a second set of clamps and rams, similarly stretching an additional coarse mesh cloth over the fine mesh cloth and tensioning it by means of a third set of clamps and rams, thereafter securing the cloths to the support frame under pressure, releasing the pressure, opening the clamping jaws, trimming surplus wirecloth back to the frame and removing the finished screen from the jig.

If two fine mesh cloths are required the second fine mesh cloth may be laid over the first fine mesh cloth before the top coarse cloth is applied. Both fine mesh cloths can be clamped with the same set of jaws and rams, or a further set of jaws and rams may be provided for tensioning the second fine mesh cloth. Where only one set of jaws is provided for the two fine mesh cloths the two cloths will have the same tension, but where a separate set of jaws and rams are provided the tension in the second fine mesh cloth may be different from that in the first fine mesh cloth.

If slippage is noted where two fine mesh cloths are clamped in the same set of jaws, the method may include the step of inserting a strip of coarser mesh cloth between the two layers locally between the clamping jaws, to assist in gripping the two fine mesh layers between the jaws.

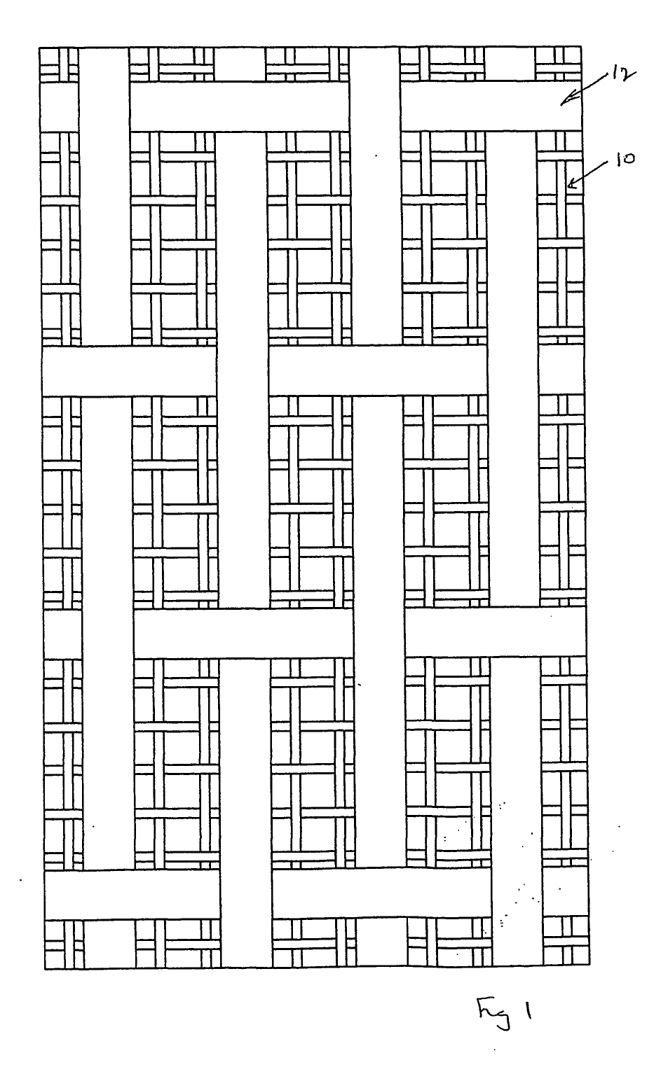

The invention will now be described by way of example with reference to the accompanying drawing in which the single FIGURE, FIG. 1, illustrates to an enlarged scale in plan view from above, a small part of a fine mesh cloth 10 overlaid by a coarse mesh cloth 12. The mesh size of 12 is such as to prevent, in general, relatively large abrasive particles from making contact with the fine mesh cloth 10. In the drawing, a backing cloth (which would be below the fine mesh cloth) has been omitted, for clarity.

All of the cloths are secured in position in manner known per se to a relatively rigid frame (not shown) by bonding to a thermoplastic material from which the screen is constructed or which covers a metal or other inner core, so as to form a screen for use in a sieving machine such as a shale shaker used to separate solids from drilling mud retrieved from down-hole during oil or gas well drilling operations.

An example of such a screen and frame and its manner of manufacture is illustrated and described in GB Patent Specification No. 2,322,590 and GB Patent Application No. 0226338.2.

1. A woven wire cloth screen in which at least one fine mesh cloth overlies a coarser mesh backing cloth and an additional coarser mesh cloth is secured over the fine mesh cloth, whose mesh and wire size at least are selected so as in general to prevent relatively large abrasive particles from making contact with the fine mesh cloth.

2. A screen as claimed in claim 1 wherein the tension in wires making up one cloth is different from the tension in the wires making up at least one of the other cloths.

3. A screen as claimed in claim 2 wherein a different tension exists in the wires making up each of the cloths.

4. A screen as claimed in claim 1 wherein the tension in the wires of each of the cloths is the same.

5. A screen as claimed in claim 1 wherein the tension in the additional coarse mesh cloth is greater than that in the fine mesh cloth(s).

6. A screen as claimed in claim 5 wherein the tension in the additional coarse mesh cloth is approximately twice the tension in the fine mesh cloths.

7. A screen as claimed in any of claims 1 to 6 claim 1 wherein two fine mesh cloths overlie the backing cloth so that one fine mesh cloth is sandwiched between the upper fine mesh cloth and the backing cloth, and the mesh size of the cloth which is so sandwiched is very close to the mesh size of the said upper fine mesh cloth, and in use assists in de-blinding the upper cloth due to relative vibrational movement between it and the lower fine mesh cloth, and the additional coarser mesh cloth overlies the upper fine mesh cloth.

8. A screen as claimed in claim 1 wherein the additional cloth has rectangular mesh openings.

9. A screen as claimed in claim 8 wherein the rectangular openings in the weave are twice as long in one direction as in the other.

10. A screen as claimed in claim 8 wherein the larger dimensions of the openings in the weave run parallel to the direction in which separated solids migrate over the surface of the screen in use.

11. A screen as claimed in claim 1 wherein the cloths are stretched over and bonded to a rigid frame.

12. A screen as claimed in claim 11 wherein the rigid frame is rectangular.

13. A screen as claimed in claim 12 which in use is arranged so that the longer dimension of the screen is parallel to the direction in which separated solids migrate over the screen.

14. A screen as claimed in claim 8 wherein the additional cloth is fitted to the frame so that the larger dimensions of the openings in the weave are parallel to the longer edges of the frame.

15. A screen as claimed in claim 1 having a single fine mesh cloth sandwiched between backing cloth and overlying additional coarse mesh cloth in which the backing cloth is 30#×0.280 mm diameter S/S wire, the fine mesh cloth is 180#×0.030 mm diameter S/S wire and the additional top cloth is 30#×60#×0.160 mm diameter S/S wire.

16. A screen as claimed in claim 7 wherein the backing cloth is 30#×01.280 mm diameter S/S wire, the upper fine mesh is 180#×0.030 mm diameter S/S wire, the lower fine mesh is 160#×0.036 mm diameter S/S wire, and the additional top cloth is 30#×60#×0.160 mm diameter S/S wire.

17. A method of making a screen as claimed in claim 1 wherein the cloths are in turn laid over a rigid frame to which they are to be bonded and the tension in the wire mesh cloths is achieved using pneumatically powered rams acting on clamps which grip the edges of the cloths, wherein all the rams are of the same size and different tensions are imparted to the cloths by supplying air at differing pressures to the rams acting on the different cloths.

18. A method as claimed in claim 17 when employed to make a screen as claimed in claim 1 in which the pressures applied to the three sets of rams are in the following ratios, backing mesh rams 2.0, fine mesh rams 1.0, and additional top mesh rams 1.9.

19. A method as claimed in claim 17 when employed to make a screen as claimed in claim 7 in which the pressures applied to the rams are in the following ratios, backing mesh rams 2.0, lower fine mesh rams 1.0, upper fine mesh rams 1.0, and additional top mesh rams 1.9.

20. A method as claimed in claim 19 wherein the two fine mesh cloths are clamped and tensioned together, using one set of clamps and rams.

21. A method of making a woven wire cloth screen which will withstand highly abrasive large particles such as obtained when drilling through Utsira sand, in which a support frame is located in a jig, a coarse backing cloth is stretched over the frame and secured between clamping jaws along all four edges and then tensioned by moving all the clamps relatively outwardly by pneumatic rams, similarly stretching a fine mesh wirecloth over the first cloth and similarly tensioning it by means of a second set of clamps and rams, similarly stretching an additional coarse mesh cloth over the fine mesh cloth and tensioning it by means of a third set of clamps and rams, thereafter securing the cloths to the support frame under pressure, releasing the pressure, opening the clamping jaws, trimming surplus wirecloth back to the frame and removing the finished screen from the jig.

22. A method as claimed in claim 21 wherein a second fine mesh cloth is laid over the first fine mesh cloth before the top coarse cloth is applied.

23. A method as claimed in claim 22 wherein the two fine mesh cloths are clamped using the same set of jaws and rams.

24. A screen as claimed in claim 1 when fitted to and used to sift drilling mud recovered from a sea-bed drilling operation progressing through sub-sea strata composed of Utsira sand.
